(19) United States
(12) Patent Application Publication
(10) Pub. No.: US 2024/0427555 A1
(43) Pub. Date: Dec. 26, 2024

(54) SYSTEM FOR GENERATING RANDOM NUMBERS AND METHOD THEREOF

(71) Applicant: Raman Research Institute, Bengaluru (IN)

(72) Inventors: Urbasi SINHA, Bengaluru, Karnataka (IN); Aninda SINHA, Bengaluru, Karnataka (IN); Pingal Pratyush NATH, Sibsagar, Assam (IN)

(21) Appl. No.: 18/750,352

(22) Filed: Jun. 21, 2024

(30) Foreign Application Priority Data
Jun. 23, 2023 (IN) 202341042304

(51) Int. Cl. G06F 7/58; H04B 10/85

(52) U.S. Cl. CPC G06F 7/582; H04B 10/85

(57) ABSTRACT

The present disclosure discloses a system and method for random number generation from a loophole-free a Legget-Garg inequality (LGI) based random number generation architecture. More specifically, the randomness of the random numbers generated by LGI based architecture is certified and quantified in a semi device-independent manner based on the violation of the Leggett Garg Inequality. Additionally, the LGI based architecture addresses clumsiness loophole, detection efficiency loophole, multi-photon emission loophole, state preparation loophole and coincidence loophole making the process completely loophole free. A number of experiments are performed using the loophole-free LGI based architecture to evaluate different coincidence measurements. The coincidence measurements are used to generate bit strings of 0's and 1's from the coincidence counts based on which the random numbers are generated.

### TECHNICAL FIELD

The present disclosure broadly relates to quantum random number generation and more specifically, to a system and method for generating random numbers by using a loophole-free Leggett Garg Inequality (LGI) based architecture.

### BACKGROUND

The following description includes information that may be useful in understanding the present invention. It is not an admission that any of the information provided herein is prior art or relevant to the presently claimed invention, or that any publication specifically or implicitly referenced is prior art.

Generation of random numbers is a central problem for many applications in the field of information processing, cryptography, in classical and quantum regime, but also mathematical modelling. They are also crucial in applications such as Monte Carlo methods for many-body simulations, statistical modelling, etc., and in a plethora of other probabilistic algorithms. Both, the quality of the randomness and efficiency of the random numbers' generation process are crucial for the most of these applications.

Computers, being deterministic by design, are capable only of generating pseudo-random numbers in the absence of access to any physical entropy source. Pseudo Random Number Generators (PRNGs) can produce sequences of numbers that appear random. However, they are not truly random, as a deterministic algorithm and a starting seed value determine their output. Hence, the random numbers generated can be accurately predicted with enough computational power and knowledge of the seed value. Devices which generate random sequences for use in high-end applications such as cryptography rely on true random number generators (TRNGs), both classical and quantum, which extract randomness from physical processes in nature. For example, the hardware based random number generators typically use physical processes like radioactive decay or thermal noise for random number generation. In another example, computers also use mouse movements or fan speed to generate random numbers. TRNGs generate true random numbers, but they are not completely independent of the hardware. As such, when the hardware degrades, the quality of random numbers also decreases. Moreover, there is no way to justify whether the random numbers generated are from the physical processes. These TRNGs cannot be trusted for security purposes as the eavesdropper can be the manufacturer who may preconfigure a random number in the memory stick, which looks perfect to a user but is unsafe for cryptographic purposes.

Due to the inherent unpredictability of quantum mechanics, random numbers based on quantum processes serve as an excellent source of randomness. Quantum random number generators (QRNGs) produce true randomness, but in this case, the trust factor between the manufacturer and the user cannot be eliminated entirely. Moreover, the present technologies are device dependent, which again has certain disadvantages, as mentioned above. A few examples of the QRNGs include Photonic QRNG, Nuclear decay QRNG, and Quantum Noise QRNG.

To overcome the limitations arising from device dependence, device independent QRNGs based on Bell measurements whose outputs can be used to certify its quantum nature have been known in the art. However, the Bell-type setup is challenging because it involves an entangled pair of photons which are sent to separate stations to be spatially separated to make the experiment loophole-free. Each of the two spatially separated parties can choose one of their photon's possible measurements. This is being done using a random source such that a measurement choice of one party is not known to the other party and vice versa. If the measurement data violates Bell Inequality after a certain number of trials, then it is assured that the random numbers generated are of purely quantum origin. The Bell-type setup is device independent because only the output data can be used to verify and quantify the randomness. However, the Bell-type setup is not compact, and is difficult to use as an efficient random number generator.

There is therefore a need for a random number generation system that overcomes the limitations mentioned above.

### SUMMARY OF INVENTION

The present disclosure overcomes one or more shortcomings of the prior art and provides additional advantages. Embodiments and aspects of the disclosure described in detail herein are considered a part of the claimed disclosure.

In one non-limiting embodiment of the present disclosure, a system for generating random numbers is disclosed. The system comprises a Legget-Garg inequality (LGI) based random number generation architecture. In one exemplary aspect, the LGI based random number generation architecture comprises a photon source configured to generate a pair of photons comprising a first photon and a second photon. The LGI based random number generation architecture further comprises a pair of dielectric mirrors placed at output path of the photon source and configured to guide the first photon in a first direction and the second photon in a second direction. In one exemplary aspect, the first direction and the second direction are opposite to each other. The LGI based random number generation architecture further comprises a plurality of detectors configured to detect the guided pair of photons. In one aspect, the plurality of detectors at least comprises a first detector, a second detector and a third detector, the first detector being placed orthogonally with respect to the photon source in the first direction and configured to detect the first photon. The LGI based random number generation architecture further comprises a pair of interferometers comprising a first interferometer and a second interferometer being placed orthogonally with respect to the photon source in the second direction such that the pair of interferometers guide the second photon towards one of: the second detector and the third detector. The LGI based random number generation architecture further comprises a first pair of blockers configured to be selectively positioned in a pair of arms of the first interferometer and a second pair of blockers configured to be selectively positioned in a pair of arms of the second interferometer. In one aspect, the first pair of blockers and the second pair of blockers are configured to selectively guide the second photon towards one of: the second detector and the third detector based on positioning of at least one blocker in at least one arm of the pair of interferometers. The system further comprises a computing unit operatively coupled to the LGI based random number generation architecture. The computing unit comprises a memory operatively coupled to a processor. In one exemplary aspect, the processor is configured to receive, from the plurality of detectors, measurement data corresponding to a plurality of measurements performed at a plurality of time instants. In one aspect the measurement data comprises a plurality of coincidence events corresponding to one of detection of the first photon at the first detector and simultaneous detection of the second photon at the second detector, and detection of the first photon at the first detector and simultaneous detection of the second photon at the third detector. The processor is further configured to detect a plurality of coincidence counts from the measurement data and generate a plurality of random numbers based on the detected plurality of coincidence counts.

In another non-limiting embodiment of the present disclosure, the first interferometer comprises a half-wave plate and a polarizing beam splitter and the second interferometer comprises a non-polarizing beam splitter.

In yet another non-limiting embodiment of the present disclosure, the plurality of time instants comprises a first time instant corresponding to time taken by the second photon to travel from the polarizing beam splitter to the non-polarizing beam splitter. The plurality of time instants further comprises a second time instant corresponding to time taken by the second photon to complete a round trip starting from the non-polarizing beam splitter. The plurality of time instants further comprises a third time instant corresponding to the time taken for the second photon to be detected at one of: the second detector and the third detector upon completing the round trip.

In yet another non-limiting embodiment of the present disclosure, to perform the measurement at the first time instant and the third time instant, the first pair of blockers are selectively positioned in the pair of arms of the first interferometer. Further, to perform the measurement at the second time instant and the third time instant, the second pair of blockers are selectively positioned in the pair of arms of the second interferometer. Furthermore, to perform the measurement at the first time instant and the second time instant, a blocker from the first pair of blockers is selectively positioned in the pair of arms of the first interferometer and a blocker from the second pair of blockers is selectively positioned in the pair of arms of the second interferometer.

In yet another non-limiting embodiment of the present disclosure, the measurement data is loophole-free.

In yet another non-limiting embodiment of the present disclosure, a method for generating random numbers using a Legget-Garg inequality (LGI) based random number generation architecture is disclosed. In one exemplary aspect, the LGI based random number generation architecture comprises a photon source configured to generate a pair of photons comprising a first photon and a second photon. The LGI based random number generation architecture further comprises a pair of dielectric mirrors placed at output path of the photon source and configured to guide the first photon in a first direction and the second photon in a second direction. In one exemplary aspect, the first direction and the second direction are opposite to each other. The LGI based random number generation architecture further comprises a plurality of detectors configured to detect the guided pair of photons. In one aspect the plurality of detectors at least comprises a first detector, a second detector and a third detector, the first detector being placed orthogonally with respect to the photon source in the first direction and configured to detect the first photon. The LGI based random number generation architecture further comprises a pair of interferometers comprising a first interferometer and a second interferometer being placed orthogonally with respect to the photon source in the second direction such that the pair of interferometers guide the second photon towards one of: the second detector and the third detector. The LGI based random number generation architecture further comprises a first pair of blockers configured to be selectively positioned in a pair of arms of the first interferometer and a second pair of blockers configured to be selectively positioned in a pair of arms of the second interferometer. In one aspect, the first pair of blockers and the second pair of blockers are configured to selectively guide the second photon towards one of: the second detector and the third detector based on positioning of at least one blocker in at least one arm of the pair of interferometers. The method comprises receiving, from the plurality of detectors, measurement data corresponding to a plurality of measurements performed at a plurality of time instants. In one aspect, the measurement data comprises a plurality of coincidence events corresponding to one of: detection of the first photon at the first detector and simultaneous detection of the second photon at the second detector, and detection of the first photon at the first detector and simultaneous detection of the second photon at the third detector. The method further comprises detecting a plurality of coincidence counts from the measurement data. Further, the method comprises generating a plurality of random numbers based on the detected plurality of coincidence counts.

In yet another non-limiting embodiment of the present disclosure, the method further comprises performing the measurement at the first time instant and the third time instant by selectively positioning the first pair of blockers in the pair of arms of the first interferometer. The method further comprises performing the measurement at the second time instant and the third time instant by selectively positioning the second pair of blockers in the pair of arms of the second interferometer. The method further comprises performing the measurement at the first time instant and the second time instant by selectively positioning a blocker from the first pair of blockers in the pair of arms of the first interferometer and by selectively positioning a blocker from the second pair of blockers in the pair of arms of the second interferometer.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The features, nature, and advantages of the present disclosure will become more apparent from the detailed description set forth below when taken in conjunction with the drawings in which like reference characters identify correspondingly throughout. Some embodiments of system and/or methods in accordance with embodiments of the present subject matter are now described, by way of example only, and with reference to the accompanying FIGS., in which:

FIG. 1 illustrates a block diagram of a system 100 for random number generation, in accordance with an embodiment of the present disclosure,

FIG. 2 depicts a flowchart illustrating an exemplary method 200 adopted by the system of FIG. 1 for certifying randomness of generated random numbers, in accordance with an embodiment of the present disclosure,

FIG. 3A illustrates a schematic representation 300A of the LGI based architecture of FIG. 1, in accordance with an embodiment of the present disclosure,

FIG. 3B illustrates a schematic representation 300B of the LGI based architecture of FIG. 1 along with the possible paths to be followed by a photon in the experimental setup, in accordance with an embodiment of the present disclosure,

FIG. 4 illustrates a block diagram 400 of a computing unit for generating random numbers, in accordance with an embodiment of the present disclosure,

FIG. 5 depicts the plurality of stages in which the experiment 500 is performed to measure coincidence events, in accordance with an embodiment of the present disclosure, and

FIG. 6 depicts a flowchart of an exemplary method 600 for random number generation based on the LGI architecture, in accordance with an embodiment of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in a computer readable medium and executed by a computer or processor, whether or not such computer or processor is explicitly shown.

### DETAILED DESCRIPTION

The foregoing has broadly outlined the features and technical advantages of the present disclosure in order that the detailed description of the disclosure that follows may be better understood. It should be appreciated by those skilled in the art that the conception and specific embodiment disclosed may be readily utilized as a basis for modifying or designing other structures for carrying out the same purposes of the present disclosure.

The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Various embodiments of the present disclosure disclose a system and method for random number generation from a loophole-free Legget-Garg inequality (LGI) based random number generation architecture (herein after referred to as LGI based architecture). More specifically, the randomness of the random numbers generated by LGI based architecture is certified and quantified in a semi device-independent manner based on the violation of the Leggett Garg Inequality. Additionally, the LGI based architecture addresses clumsiness loophole, detection efficiency loophole, multi-photon emission loophole, state preparation loophole and coincidence loophole making the process completely loophole free. A number of experiments are performed using the loophole-free LGI based architecture to evaluate different coincidence measurements. More specifically, the temporal correlations of a quantum system with two degrees of freedom is determined by measuring the quantum system at different instants of times. The measurements of the quantum system at different instants of time are used to generate bit strings of 0's and 1's from the coincidence counts based on which detector in the loophole-free Leggett Garg architecture clicked. As such, a number of experiments are performed by placing blockers at different arms in the loophole-free LGI based architecture at different instants of time to generate different bit strings from the measurements made at different instances of time. Accordingly, each bit string is of a different length.

The term ‘random number generation’ as used herein refers to generation of random numbers based on violation of LGI in a loophole-free way. More specifically, a LGI based setup is used to evaluate different coincidence measurements by measuring the photon detection/no detection in a LGI based architecture at different instants of times for random number generation. Such coincidence measurements at different instants of time are used to generate a bit string of 0's and 1's from the coincidence counts based on which photon detector in the loophole-free LGI based architecture clicked. The random numbers generated may be of variable length due to different nature of correlations in the temporal measurements as will be explained later.

The term ‘coincidence event’ as used herein refers to detection of a photon between two detectors within a specified timeframe (also referred to herein as ‘a coincidence window’). More specifically, these photons are detected between the two detectors in a coincidence time window. For example, a first detector detects a photon a time instant t₁ and a second detector detects the photon at a time instant t₂. In an embodiment, the coincidence time window is selected such that background noise is minimal. It shall be noted that only the coincidence events occurring within the selected time window are considered as valid coincidence counts. Detection of coincidence events in a LGI based architecture has been explained with reference to FIG. 5.

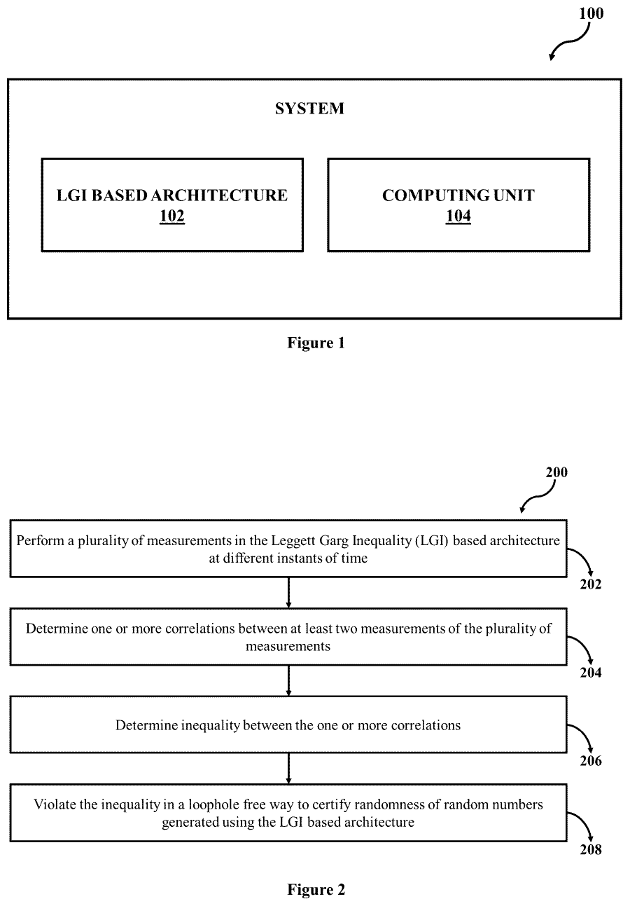

FIG. 1 illustrates a schematic representation of a system 100 for generating random numbers, in accordance with an embodiment of the present disclosure. The system 100 includes a LGI based architecture 102 and a computing unit 104. The LGI based architecture 102 is used to generate the randomness by exploiting the temporal correlations within a quantum system with two degrees of freedom, by measuring the LGI based architecture 102 at different instances of times. The measurements from the LGI based architecture 102 are provided to the computing unit 104 which processes the measurements to generate the random numbers. More specifically, the measurements at different instances of time are used to detect coincidence events and the random numbers are generated based on the coincidence events as will be explained in detail in the forthcoming paragraphs.

In general, the objective of the disclosure is to generate random numbers that are certified based on the violation of Leggett Garg Inequality using the LGI based architecture 102. Additionally, the certification of random numbers is based on another condition i.e., the satisfaction of No Signaling in Time (NSIT) condition that is satisfied by performing the experiment in a loophole free way. An exemplary flow diagram depicting the process for certifying randomness of generated random numbers is explained next with reference to FIG. 2.

FIG. 2 depicts a flowchart illustrating an exemplary method 200 adopted by the system of FIG. 1 for certifying randomness of generated random numbers, in accordance with an embodiment of the present disclosure.

At step 202, the method 200 may include performing a plurality of measurements in the LGI based architecture 102 at different instances of time.

At step 204, the method 200 may include determining one or more correlations between at least two measurements of the plurality of measurements.

At step 206, the method 200 may include determining inequality between the one or more correlations. In an embodiment, the inequality to be determined between the one or more correlations is Leggett-Garg inequality. The Leggett-Garg inequality is used to test the validity of quantum mechanics by studying the temporal correlations of the LGI based architecture 102 (i.e., a quantum system). In general, any system which has two or more possible states and are measured at three different times (specifically in the case of LGI), the results of those measurements must be correlated in a certain way. Leggett and Garg used this to derive a bound on the temporal correlations. The inequality is based on the assumptions of macroscopic realism and Non-invasive measurability, which are satisfied by any classical theories.
Macroscopic realism: A system with multiple distinct states will be at either one or other of these states at any instant.
Non-invasive measurability: It is possible to measure the state of a system with arbitrary small perturbations in its subsequent dynamics.

At step 208, the method 200 may include violating the inequality in a loophole free way to certify randomness of random numbers generated using the LGI based architecture 102. The violation of Leggett Garg inequality implies that it is either impossible to make a measurement on the system (here, the LGI based architecture 102) without disturbing it, or the macroscopic description of the system is ruled out.

Let Q be a dichotomic variable with eigenvalues +1 and −1. The Leggett Garg inequality can be represented as shown below in Equation (1):

$$〈 {Q}_{1} {Q}_{2} 〉 + 〈 {Q}_{2} {Q}_{3} 〉 - 〈 {Q}_{1} {Q}_{3} 〉 \leq 1 \qquad ( 1 )$$

where Qi=Q (tᵢ) is the outcome of the measurement made at time tᵢ with the flow of time given by, t₁<t₂<t₃. The correlation functions are defined as,

$$〈 {Q}_{i} {Q}_{j} 〉 = {\sum }_{{Q}_{i} {Q}_{j} = \pm 1} {Q}_{i} {Q}_{j} {P}_{ij} ( {Q}_{i} , {Q}_{j} ) \qquad ( 2 )$$

where Pᵢⱼ(Qᵢ, Qⱼ) is the probability of getting the outcomes
Qᵢ and Qⱼ with the indices ij indicating the times at which the measurement is being made. Quantum mechanics violates this inequality with an upper bound of 1.5. Quantum mechanics allows superposition and wave function collapse due to measurement, violating both Macroscopic realism and non-invasive measurability. There is another variation of this inequality which can be evaluated using three of the above probabilities and is referred to as the Wigner's form of Leggett Garg Inequalities or WLGI and is represented as,

$${P}_{t 1 , t 3} ( - , + ) - {P}_{t 1 , t 2} ( - , + ) - {P}_{t 2 , t 3} ( - , + ) \leq 0 \qquad ( 3 )$$

The WLGI inequality has an upper bound of 0.4034, which is obtained from the quantum mechanical treatment.

### Protocol for Randomness Generation-

The LGI inequalities may also be derived using the assumptions of No Signaling In Time (NSIT) and predictability, which is used to generate randomness.

No Signalling in time (NSIT): A measurement doesn't change the outcome statistics of a later measurement. In terms of probabilities NSIT demands that the probability P(x_{A′}|M_{A′}, S_{A}, S_{A′}, λ) without any earlier measurement must be same as the sum over all the earlier measurements P(x_{A}, x_{A′}|M_{A},M_{A′}, S_{A}, S_{A′}, λ), which can be written down mathematically as,

$$P ( {x}_{{A}^{′}} \vert {m}_{{A}^{′}} , λ ) = {\sum }_{{x}_{A}} P ( {x}_{A} , {x}_{A ′} \vert {m}_{A} , {m}_{A ′} , λ ) \qquad ( 4 )$$

where S_{A} and S_{A′} denote the state of the system at times t_{A} and t_{A}′ at which the measurements m_{A} and m_{A}, are being made and x_{A} and x_{A}, are the outputs of the measurements m_{A} and m_{A}, respectively.

Predictability: A model is said to be predictable if the joint operational statistics P(x_{A}, x_{A},|m_{A}, M_{A},, λ)∈{0, 1} for the measurements at any time and for all measurement outcomes. So, predictability implies,

$$P ( {x}_{A} , {x}_{A ′} \vert {m}_{A} , {m}_{A ′} , λ ) ∈ \{ 0 , 1 \} \qquad ( 5 )$$

One of the crucial steps in the derivation of LGI, is the factorizability relation which follows from the assumption of Induction which is defined as “the outcome of a measurement on a system is not affected by what will or will not be measured on it later” and macro realism and can be written down as,

$$P ( {x}_{A} , {x}_{A ′} \vert {m}_{A} , {m}_{A ′} , λ ) = P ( {x}_{A} \vert {m}_{A} , λ ) * P ( {x}_{{A}^{′}} \vert {m}_{A ′} , λ ) \qquad ( 6 )$$

The conjunction of Predictability and NSIT gives rise to this factorizability relation which further leads to LGI and can be written down as the following Lemma.
Lemma 1: Predictability
Λ No Signaling in time⇒LGI.

Hence, measurements that violate the LGI and satisfy the NSIT criterion gives rise to unpredictable outcomes, acting as a random source. This is because the LGI is a constraint on the predictability of a system's future behaviour based on its past behaviour, and the NSIT criterion states that the behaviour of a system (i.e., LGI based architecture 102) at a future time should not depend on the choice of measurements performed on the system at an earlier time. When both of these conditions are satisfied, a measurement produces an outcome that cannot be predicted with certainty based on the system's state when the measurement is performed. This lack of predictability can be seen as a form of randomness, as any known factors do not determine the measurement outcome. This unpredictability can be helpful in security applications where a source of randomness is needed, such as in cryptographic protocols, as a test can be devised to validate the quantum nature of these random numbers.

### Certification and Quantification of Generated Randomness-

As such, the LGI based architecture 102 uses a photon-based setup with two path degrees of freedom and projective measurements were made at times t₁, t₂, and t₃. The following assumptions were made for random number generation.
1. The dimension of the system is two. This assumption clearly follows from the LGI based architecture 102 since the measurements are performed on the spatial degrees of freedom, and there are two paths in the experimental setup.
2. The measurement at time t₁ and t₂ are perfect projective measurements, and the blockers do not signal to each other and to the detectors.
3. The choice of measurement time is uncorrelated with the state of the system.

The state of the photon is parameterized using the three parameters nₓ, n_{y}, n_{z} and can be written down as,

$$\begin{matrix}ρ = 1 / 2 ( l + \vec{n} \cdot \vec{σ} ) , & \vec{n} = ( {n}_{x} , {n}_{y} , {n}_{z} ) ∈ {R}^{3}\end{matrix} \qquad ( 7 )$$

such that nₓ²+n_{y}²+n_{z}²≤1. The time evolution from t₁→t₂ and t₂→t₃ is performed using the unitaries U₁ and U₂, respectively. They are parameterized using three parameters xᵢ, yᵢ, zᵢ and can be written down as,

$${U}_{i} = ( \begin{matrix}{e}^{{ix}_{i}} cos [ {z}_{i} ] & {e}^{{iy}_{i}} sin [ {z}_{i} ] \\ - {e}^{- {iy}_{i}} sin [ {z}_{i} ] & - {e}^{- {ix}_{i}} cos [ {z}_{i} ]\end{matrix} ) , for i = 1 , 2 \qquad ( 8 )$$

$$where , {x}_{i} , {y}_{i} , {z}_{i} ∈ R .$$

The measurement at times t₁ and t₂ is performed using the projective measurement,

$${P}_{+} = ( \begin{matrix}1 & 0 \\ 0 & 0\end{matrix} ) , {P}_{-} = ( \begin{matrix}0 & 0 \\ 0 & 1\end{matrix} ) \qquad ( 9 )$$

The measurement at t₃ is a generalized Positive Operator Valued Measure (POVM) measurement defined by two positive operators M₊, M₋≥0 such that M₊+M₋=I, which can be expressed as

$$\begin{matrix}{M}_{\pm } = \frac{1}{2} ( 1 \pm a ) I \pm \vec{b} \vec{σ} , & \vec{b} ∈ {ℝ}^{3} , & a ∈ ℝ\end{matrix} \qquad ( 10 )$$

$$where \vert \vec{b} \vert ⩽ 1 and \vert \vec{b} \vert + \vert a \vert ⩽ 1.$$

Without loss of generality, VM_{±}V^{†} is considered for any unitary V by absorbing V into U₂. Thus, M_{±} are taken as diagonal as follows—

$$\begin{matrix}{M}_{\pm } = \frac{1}{2} ( 1 \pm a ) {I}^{} \pm b {σ}_{z} , & a ∈ ℝ , & b ∈ {ℝ}^{+}\end{matrix} \qquad ( 11 )$$

$$and$$

$$\vert a \vert + b ⩽ 1 , b ⩽ 1. \qquad ( 12 )$$

Using these states, unitaries, and measurements, the probabilities P (ab|xy) are evaluated. The next step is to quantify the randomness using this probability distribution. More specifically, minimum entropy is used as a measure to quantify the amount of uncertainty or randomness that can be generated from the LGI based architecture 102. One way to calculate the minimum entropy of the LGI based architecture 102 is to consider the number of possible states that the system (i.e., here, the LGI based architecture 102) can be in and the probability of each state. The minimum entropy is then calculated as the negative logarithm of the probability of the most likely state. This is based on the idea that the more likely a state is to occur, the less random or uncertain it is. The minimum entropy for this probability distribution is defined as,

$$H ∞ ( AB / XY ) = - log \{ {max}_{ab} P ( ab \vert xy ) \} = - {min}_{ab} log \{ P ( ab \vert xy ) \}$$

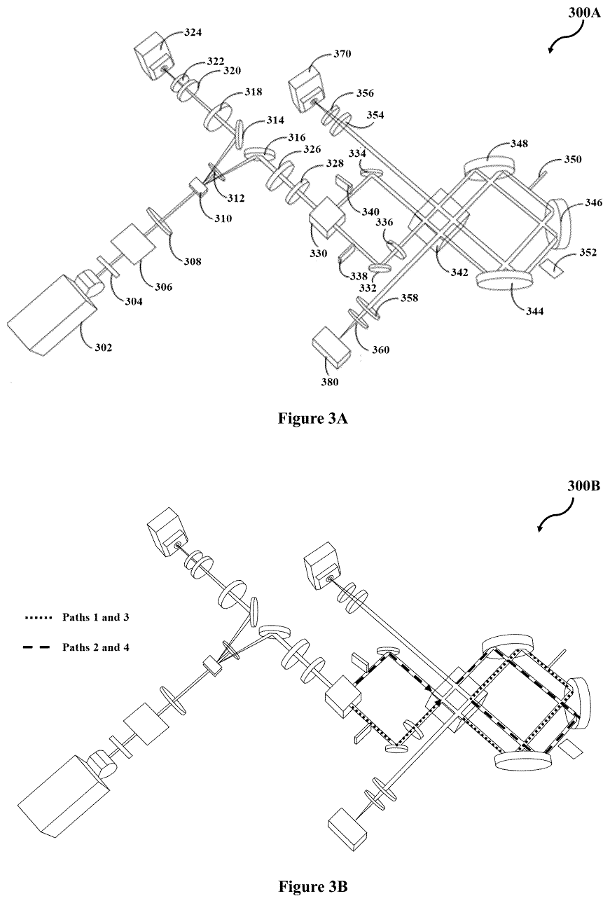

The minimum entropy achieved by the LGI based architecture 102 exceeds the lower bound set by quantum mechanics and hence are of quantum nature. Thus, the LGI based architecture 102 may act as an excellent source of randomness and is used to generate random numbers that are certified. The generation of the random numbers is described in detail in the upcoming paragraphs in conjunction with FIGS. 3-5.

FIG. 3A illustrates a schematic representation of the LGI based architecture 102 of FIG. 1, in accordance with an embodiment of the present disclosure. The LGI based architecture 102 shown in FIG. 3A is an exemplary setup or exemplary arrangement of optical components to violate the Leggett Garg Inequality for generating randomness. However, it shall be noted that the LGI based architecture 102 may include fewer or more optical components which may be arranged in a different form than the setup shown in FIG. 3A to violate the Leggett Garg Inequality for generating randomness. In general, any arrangement of optical components to violate Leggett Garg Inequality which has provisions for measuring coincidence events in the arrangement at different instances of times and to measure the temporal correlations between the different measurements may be considered as the LGI based architecture 102. Additionally, the LGI based architecture 102 addresses clumsiness loophole, detection efficiency loophole, multi-photon emission loophole, state preparation loophole and coincidence loophole. Hence, any arrangement of optical components to violate LGI must also eliminate the clumsiness loophole, the detection efficiency loophole, the multi-photon emission loophole, the state preparation loophole and the coincidence loophole to ensure that the measurements are loophole free.

The LGI based architecture 102 includes a photon source comprising an arrangement of components 302-312. In one embodiment, the photon source 302-312 may be a heralded single-photon source. Any alternate single photon source may be used as well. The photon source 302-312 includes a diode laser 302 which pumps a Beta Barium Borate (BBO) crystal 310 with a continuous wave of light at a central wavelength of 405 nm and pump power of 10 mW. The BBO crystal 310 is oriented in such a way that the BBO crystal's 310 phase is matched for degenerate, noncollinear, type-I SPDC while being pumped with horizontally polarized light. To make the input pump beam Gaussian, an arrangement of optical components for spatial filtering, including a focusing lens 308, a pinhole, and a collimating lens are used. In particular, the focusing lens 308 focuses the pumped beam into the central spot of the BBO crystal 310 so as to increase single photon pair generation. To make the pump beam horizontally polarized, a combination of a half-wave plate 304 and a polarizing beam splitter 306 is used. Parametric down-conversion creates pairs of single photons, both with vertical polarization and a central wavelength of 810 nm. A long-pass filter 312 is placed after the BBO crystal 310 to block the pump beam and pass only the down-converted single-photon pairs.

Further, a pair of dielectric mirrors 314, 316 are placed at output path of the photon source 302-312 to guide a first photon from the generated pair of photons in a first direction towards a first detector 324 for heralding, and a second photon in a second direction towards an experimental setup comprising a pair of interferometers such that the second photon is detected by one of: a second detector 370 and a third detector 380 placed in the output arms of a second interferometer of the pair of interferometers. In one exemplary embodiment, the first detector 324 is placed orthogonally with respect to the photon source 302-312 in the first direction and the pair of interferometers are also placed orthogonally with respect to the photon source 302 but in the second direction that is opposite to the first direction. In one exemplary embodiment, the first detector 324, the second detector 370 and the third detector 380 are single-photon avalanche detectors with a maximum quantum efficiency of 80% at 800 nm wavelength.

Now, the first photon that is guided towards the first detector 324 for heralding passes through a collimating lens 318, a focusing lens 320 and band pass filter 322 before being detected by the first detector 324 so as to remove any background noise and efficiently focus the first photon onto the first detector 324. On similar lines, a focussing lens 354 and a bandpass filter 356 are placed in front of the second detector 370 and a focussing lens 358 and a bandpass filter 360 are placed in front of the third detector 380 so as to efficiently focus the second photon onto the second detector 370 and the third detector 380 depending upon the path followed by the second photon, and simultaneously remove any background noise.

As described in the preceding paragraphs, the LGI based architecture 102 comprises a pair of interferometers. In one exemplary embodiment, a first interferometer of the pair of interferometers is an asymmetric Mach-Zehnder interferometer (AMZI) and a second interferometer of the pair of interferometers is a displaced Sagnac interferometer (DSI). The first interferometer comprises two mirrors 332, 334 arranged in a pair of arms of the first interferometer. The mirrors 332, 334 are made asymmetric by introducing a path difference of a few millimetres between the two arms of the first interferometer by slightly shifting the position of the mirror 334 in a second arm of the first interferometer. This modification makes the two arms of the first interferometer non-interfering as the coherence length of the single photons (typically hundreds of micrometres) is well below the path difference. A combination of a Half Wave Plate (HWP) 328 and a Polarized Beam Splitter (PBS) 330 controls the beam splitting ratio in the two arms of the first interferometer. Another HWP 336 placed in the first arm of the first interferometer converts the horizontally (H) polarized photon back to vertically (V) polarized.

The second interferometer comprises a single nonpolarizing beam splitter (NPBS) 342 with a measured splitting ratio of T:R=80:20 (with respect to vertically polarized light at 810 nm wavelength). All alignments in the second interferometer are catered to achieve optimal interference visibility and stability for both input arms, simultaneously.

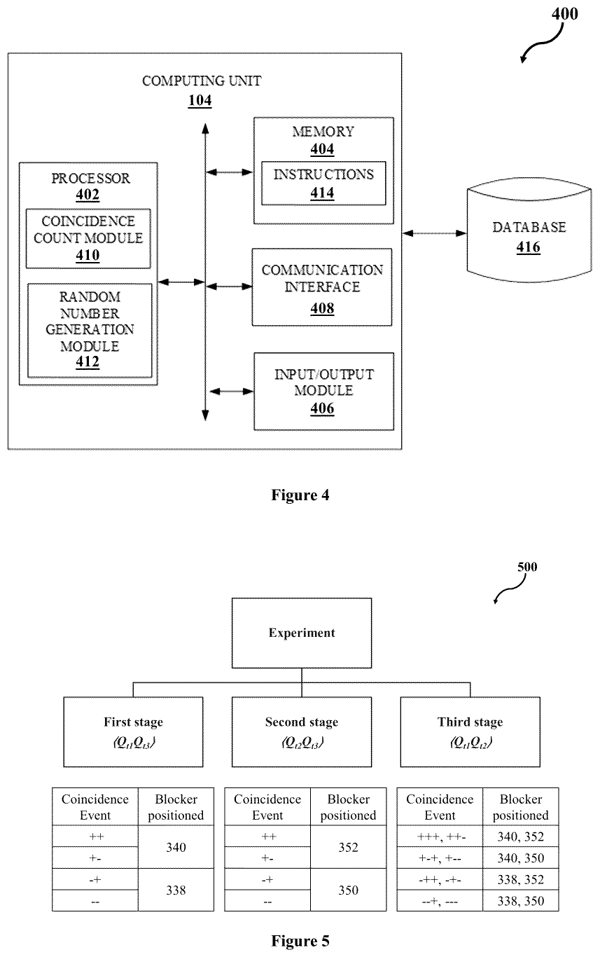

The LGI based architecture 102 further includes a first pair of blockers 338, 340 configured to be selectively positioned in the pair of arms of the first interferometer and a second pair of blockers 350, 352 configured to be selectively positioned in the pair of arms of the second interferometer so as to selectively guide the second photon towards one of: the second detector 370 and the third detector 380 based on positioning of at least one blocker in at least one arm of the pair of interferometers. In particular, at least one blocker is selectively positioned in the at least one arm of the pair of interferometers so as to perform negative result measurements at a plurality of time instants as will be explained in detail in the upcoming paragraphs. Further, measurement data corresponding to each experiment performed in the LGI-based architecture 102 is fed to the computing unit 104 for generation of random numbers. The operations performed by the computing unit 104 are explained in the forthcoming paragraphs in conjunction with FIG. 4.

FIG. 4 illustrates a block diagram of the computing unit 104 configured to generate random numbers, in accordance with an embodiment of the present disclosure. In an embodiment, the computing unit 104 is a standalone processor embodied within a security system capable of generating the random numbers for applications which require unpredictable random number sequences. In another embodiment, the computing unit 104 is a distributed or centralized server capable of performing one or more of the operations described herein.

The computing unit 104 is depicted to include a processor 402, a memory 404, an Input/Output module 406, and a communication interface 408. It shall be noted that, in some embodiments, the computing unit 104 may include more or fewer components than those depicted herein. The various components of the computing unit 104 may be implemented using hardware, software, firmware or any combinations thereof. Further, the various components of the computing unit 104 may be operably coupled with each other. More specifically, various components of the computing unit 104 may be capable of communicating with each other using communication channel media (such as buses, interconnects, etc.). It is also noted that one or more components of the computing unit 104 may be implemented in a single server or a plurality of servers, which are remotely placed from each other.

In one embodiment, the processor 402 may be embodied as a multi-core processor, a single core processor, or a combination of one or more multi-core processors and one or more single core processors. For example, the processor 402 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like. In an embodiment, the processor 402 includes a coincidence count module 410 and a random number generation module 412.

In one embodiment, the memory 404 is capable of storing machine executable instructions, referred to herein as instructions 414. In an embodiment, the processor 402 is embodied as an executor of software instructions 414. As such, the processor 402 is capable of executing the instructions 414 stored in the memory 404 to perform one or more operations described herein. The memory 404 can be any type of storage accessible to the processor 402 to perform functions as will be described herein. For example, the memory 404 may include one or more volatile or non-volatile memories, or a combination thereof. For example, the memory 404 may be embodied as semiconductor memories, such as flash memory, mask ROM, PROM (programmable ROM), EPROM (erasable PROM), RAM (random access memory), etc. and the like.

In an embodiment, the processor 402 is configured to execute the instructions 414 for: (1) receiving measurement data in relation to a plurality of time instants from the plurality of detectors 324, 370, 380 for each experiment, (2) detect coincidence events in relation to each experiment based on the measurement data, and (3) generate random numbers based on the coincidence events detected in relation to each experiment. It may be noted by a skilled person that the term ‘experiment’ as used herein refers to a setup of the LGI based architecture 102 in which one or more blockers are placed in a specific arm for performing measurements at different instances of time.

In an embodiment, the I/O module 406 may include mechanisms configured to receive inputs from and provide outputs to peripheral devices such as, receive measurement data from the plurality of detectors 324, 370, 380 and/or display the random numbers to an operator of the computing unit 104. The term ‘operator of the computing unit 104’ as used herein may refer to one or more individuals, whether directly or indirectly, associated with managing the LGI based architecture 102 for generating random numbers. To enable reception of inputs and provide outputs to the computing unit 104, the I/O module 406 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, and the like.

The communication interface 408 may include mechanisms configured to communicate with external entities, for example, the detectors 324, 370 and 380 in the LGI based architecture 102. In other words, the communication interface 408 is configured to receive measurement data in relation to a plurality of time instants from a plurality of detectors 324, 370, 380 for each experiment. In accordance with an embodiment of the present disclosure, the experiment is performed in different stages comprising a first stage, a second stage and a third stage. In particular, during each stage, a plurality of measurements are performed by selectively positioning one or more blockers in specific arms of the first and second interferometers to detect coincidence events between the first detector 324 and the second detector 370, and the first detector 324 and the third detector 380. The positioning of the blockers and the different stages in which the measurements are performed is explained in detail with reference to FIG. 5. In an embodiment, the measurements are performed at time instances t₁, t₂ and t₃ and these measurements are referred to as ‘measurement data’ hereinafter. The time instances 11, t₂ and t₃ are defined as follows:
t₁ is the time taken by the second photon to travel from polarizing beam splitter 330 to the first impact on the non-polarizing beam splitter 342
t₂ is the time taken by the second photon to complete a round trip starting from the non-polarizing beam splitter 342
t₃ is the corresponding to the time taken for the second photon to be detected at one of: the second detector 370 and the third detector 380 upon completing the round trip.

FIG. 5 depicts the plurality of stages in which the experiment is performed to measure coincidence events, in accordance with an embodiment of the present disclosure. As shown in FIG. 5, the experiment is completed in three stages corresponding to the measurement of [symbol] Qₜ₁Qₜ₃ [symbol] , [symbol] Qₜ₂Qₜ₃ [symbol] and [symbol] Qₜ₁Qₜ₂ [symbol] in the LGI based architecture 102, respectively. It shall be noted that the experiments and the measurements as described herein are for example purposes and the experiments, measurements may change depending on the arrangement of optical components to form the LGI based architecture 102.

The first stage of the experiment corresponds to the measurement of [symbol] Qₜ₁Qₜ₃ [symbol] . For measuring [symbol] Qₜ₁Qₜ₃ [symbol] , two runs are performed. In the first run, coincidence events ++ and +− are detected by positioning blocker 340 in corresponding arm of the first interferometer. The positioning of blocker 340 in corresponding arm of the first interferometer, prohibits the second photon from travelling through path 2 as depicted in FIG. 3B. Therefore, the second photon travels through path 1 and gets detected at the second detector 370 corresponding to coincidence event ++ or gets detected at the third detector 380 corresponding to coincidence event +−. Similarly, in the second run, coincidence events −+ and −− are detected by positioning blocker 338 in corresponding arm of the first interferometer. The positioning of blocker 338 in corresponding arm of the first interferometer, prohibits the second photon from travelling through path 1 as depicted in FIG. 3B. Therefore, the second photon travels through path 2 and gets detected at the second detector 370 corresponding to coincidence event −+ or gets detected at the third detector 380 corresponding to coincidence event −−. It may be noted by a skilled person that the first run and the second run are interchangeable.

The second stage of the experiment corresponds to the measurement of [symbol] Qₜ₂Qₜ₃ [symbol] . For measuring [symbol] Qₜ₂Qₜ₃ [symbol] , two runs are performed. In the first run, coincidence events ++ and +− are detected by positioning blocker 352 in corresponding arm of the second interferometer. The positioning of blocker 352 in corresponding arm of the second interferometer, prohibits the second photon from travelling through path 4 as depicted in FIG. 3B. Therefore, the second photon travels through path 3 and gets detected at the second detector 370 corresponding to coincidence event ++ or gets detected at the third detector 380 corresponding to coincidence event +−. Similarly, in the second run, coincidence events −+ and −− are detected by positioning blocker 350 in corresponding arm of the second interferometer. The positioning of blocker 350 in corresponding arm of the first interferometer, prohibits the second photon from travelling through path 3 as depicted in FIG. 3B. Therefore, the second photon travels through path 4 and gets detected at the second detector 370 corresponding to coincidence event −+ or gets detected at the third detector 380 corresponding to coincidence event −−. It may be noted by a skilled person that the first run and the second run are interchangeable.

The third stage of the experiment corresponds to the measurement of [symbol] Qₜ₁Qₜ₂ [symbol] . For measuring, four runs are performed. In the first run, the coincidence events +++ and ++− are detected by positioning blockers 340 and 352 in corresponding arms of the first interferometer and the second interferometer respectively. The positioning of blockers 340 and 352 in corresponding arms of the first interferometer and the second interferometer respectively, prohibits the second photon from travelling through paths 2 and 4 as depicted in FIG. 3B. Therefore, the second photon travels through paths 1 and 3 and gets detected at the second detector 370 corresponding to coincidence event +++ or gets detected at the third detector 380 corresponding to coincidence event ++−. In the second run, the coincidence events +−+ and +−− are detected by positioning blockers 340 and 350 in corresponding arms of the first interferometer and the second interferometer respectively. The positioning of blockers 340 and 350 in corresponding arms of the first interferometer and the second interferometer respectively prohibits the second photon to travel through paths 1 and 4 as depicted in FIG. 3B. Therefore, the second photon travels through paths 2 and 3 and gets detected at the second detector 370 corresponding to coincidence event +−+ or gets detected at the third detector 380 corresponding to coincidence event +−−. In the third run, the coincidence events −++ and −+− are detected by positioning blockers 338 and 352 in corresponding arms of the first interferometer and the second interferometer respectively. The positioning of blockers 338 and 352 in corresponding arms of the first interferometer and the second interferometer respectively, prohibits the second photon from travelling through paths 1 and 4 as depicted in FIG. 3B. Therefore, the second photon travels through paths 2 and 3 and gets detected at the second detector 370 corresponding to coincidence event −++ or gets detected at the third detector 380 corresponding to coincidence event −+−. In the fourth run, the coincidence events −−+ and −−− are detected by positioning blockers 338 and 350 in corresponding arms of the first interferometer and the second interferometer respectively. The positioning of blockers 338 and 350 in corresponding arms of the first interferometer and the second interferometer respectively, prohibits the second photon from travelling through paths 1 and 3 as depicted in FIG. 3B. Therefore, the second photon travels through paths 2 and 4 and gets detected at the second detector 370 corresponding to coincidence event −−+ or gets detected at the third detector 380 corresponding to coincidence event −−−.

Further, to ensure the experiment is loophole-free, various measures are taken. The clumsiness loophole is addressed using non-invasive measurements (NIM) and tuning the experimental parameters to satisfy the two-time NSIT condition. The detection efficiency loophole is eliminated by showing that the violation of LGI cannot be reproduced by the hidden variable model, regardless of detection efficiency. The multi-photon emission loophole is addressed using a heralded single-photon source and appropriate filtering. The coincidence loophole is eliminated by using a pair of photons as a timing reference and adjusting the coincidence time windows accordingly. Finally, the preparation state loophole is closed by post selecting only those detected photons that come from the photon source 302-312 and choosing high signal-to-noise ratios for the corresponding coincidence time windows.

Referring back to FIG. 4, the measurement data corresponding to each stage of the experiment is provided to the processor 402. The processor 402 in conjunction with the instructions 414 in the memory 404 is configured to perform one or more operations described herein to generate the random numbers. It shall be noted that the measurement data related to the photon at different time instances for each experiment from the detectors 324, 370, 380 of the LGI based architecture 102 may be conditioned prior to processing by the processor 402. Accordingly, the computing unit 104 may also include other components for pre-processing the measurement data received from the detectors 324, 370, 380.

Further, the computing unit 104 is depicted to be in operative communication with a database 416. In one embodiment, the database 416 is configured to store information related to each experiment such as, position of blockers 338, 340, 350, 352, historical measurement data, random numbers generated, etc. The database 416 may include multiple storage units such as hard disks and/or solid-state disks in a redundant array of inexpensive disks (RAID) configuration. In some embodiments, the database 416 may include a storage area network (SAN) and/or a network attached storage (NAS) system. In one embodiment, the database 416 may correspond to a distributed storage system, wherein individual databases are configured to store custom information, such as, information related to time instances, blocker position, historical coincidence counts, etc.

In some embodiments, the database 416 may be integrated within the computing unit 104. For example, the computing unit 104 may include one or more hard disk drives as the database 416. In other embodiments, the database 416 is external to the computing unit 104 and may be accessed by the computing unit 104 using a storage interface (not shown in FIG. 4). The storage interface is any component capable of providing the processor 402 with access to the database 416. The storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the database 416.

As already explained, the communication interface 408 is configured to receive the measurement data from the detectors 324, 370 and 380 in the LGI based architecture 102 and forward the measurement data to the processor 402. The processor 402 in conjunction with the instructions 414 in the memory 404 is configured to process the measurement data for generating random numbers. The processor 402 sends the measurement data to the coincidence count module 410.

In an embodiment, the coincidence count module 410 is configured to determine coincidence counts from the measurement data. In an embodiment, the coincidence counts are detected in a coincidence time window based on the measurements for each of the experiments. In an example, the coincidence time window of 4 ns has been used for detecting the coincidence counts. Further, coincidence counts in the LGI based architecture 102 implies either of the following scenarios-
1) Detectors 324 and 370 clicked at the same time or within a given time interval (i.e., coincidence window).
2) Detector 324 and 380 clicked at the same time or within a given time interval i.e., coincidence window).

In an embodiment, the random number generation module 412 is configured to generate random numbers based on the coincidence counts. In an example, random bit 0 is assigned when detectors 324 and 370 clicked and random bit 1 is assigned when detectors 324 and 380 clicked. So, each coincidence count that is detected from the time stamps and channel numbers refer to any one of the scenarios thereby either generating bits 0 or 1. All the coincidence counts from the experiment will hence generate a random bit string of 0's and 1's.

For instance, for the evaluation of the probabilities P(aᵢ, aⱼ|Qₜ₁, Qₜ₃) and P(aᵢ, aⱼ|Qₜ₂, Qₜ₃) in the first and second stages of the experiment, two sub-runs were conducted for each experiment. In one sub-run, the path 1 of the first interferometer was blocked, and in the other sub-run, the path 2 of the first interferometer was blocked. In the first case, if the second photon from the experimental setup coincidentally hit the second detector 370 with the first detector 324, it was counted as ‘0’. If it coincidentally hit the third detector 380 with the first detector 324, it was counted as ‘1’, thus generating a bit string for this sub-run and resulting in the probabilities P(−+|Qₜ₁, Qₜ₃) and P (−−|Qₜ₁, Qₜ₃). Similarly, for the second sub-run where path 2 was blocked, a bit string was generated based on the detector clicks, leading to the probabilities P(++|Qₜ₁, Qₜ₃) and P(+−|Qₜ₁,Qₜ₃).

Likewise, two more bit strings were generated from the second stage of the experiment, providing the probabilities P(aᵢ, aⱼ|Qₜ₂, Qₜ₃). However, the third phase of the experiment, aimed at computing correlations at times t₁ and t₂, involved marginalizing the three-time probabilities P(aᵢ, aⱼ, aₖ|Qₜ₁, Qₜ₂, Qₜ₃). In this case, blockers were placed simultaneously on both interferometers in different arms, enabling the computation of all the three-term probabilities in 4 runs. Although these bit strings did not directly originate from the two-term probabilities P(aᵢ, aⱼ|Qₜ₁, Qₜ₂), which occur in the LGI expression used for certifying randomness, they eventually contributed to the computation of two-term probabilities. They thus could be used to certify and quantify the randomness.

In an example, the measurement settings for generating random bit strings is shown below in Table 1.

TABLE 1
Measurement settings for generation of random bit strings

| Experiment | Rate (bits/sec) | Length |
|---|---|---|
| P (23 \| − −) P (23 \| − +) | 4722 | 140382 |
| P(23 \| + −) P(23 \| ++) | 5139 | 152405 |
| P(123 \| + − −) P(23 \| + − +) | 1177 | 34981 |
| P(123 \| ++−) P(123 \| +++) | 4268 | 127123 |
| P(123 \| − − −) P(123 \| − − +) | 3953 | 117651 |
| P(123 \| − + −) P(123 \| − ++) | 1180 | 34935 |
| P(13 \| + −) P(13 \| + +) | 5158 | 153465 |
| P(13 \| − − )P(13 \| − +) | 5321 | 158176 |

Subject to the conditions assumed in this approach, eight distinct bit strings were generated as depicted in the above table 1. The average generation rate was 3865 bits/second and the total number of bits generated, which is the sum of the 8-bit strings generated, is 9, 19, 118. Each bit string had an appropriate length and successfully passed the SP-800-90B entropy test for randomness.

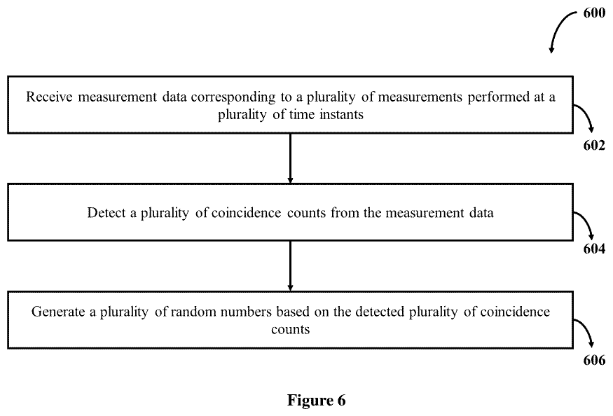

FIG. 6 depicts a flowchart illustrating an exemplary method 600 adopted by the computing unit 104 of FIG. 1 for generating random numbers, in accordance with an embodiment of the present disclosure.

At step 602, the method 600 may include receiving from the plurality of detectors, measurement data corresponding to a plurality of measurements performed at a plurality of time instants. In one embodiment, the measurement data comprises a plurality of coincidence events corresponding to one of: detection of the first photon at the first detector and simultaneous detection of the second photon at the second detector, and detection of the first photon at the first detector and simultaneous detection of the second photon at the third detector. Further, the measurement data may be received by the processor 402 of the computing unit 104 via the communication interface 408.

At step 604, the method 600 may include detecting a plurality of coincidence counts from the measurement data comprising the coincidence events. In an embodiment, for detection of coincidence counts, the coincidence count module 410 is used. In an embodiment, the coincidence counts are detected in a coincidence time window based on the measurements for each of the experiments. In an example, the coincidence time window of 4 ns has been used for detecting the coincidence counts.

At step 608, the method 600 may include generating random numbers based on the plurality of coincidence counts detected from the measurement data. For said random number generation, the random number generation module 412 may be used. In particular, the random number generation module 412 may use the coincidence counts to generate a bit strings of 0's and 1's.

The sequence of operations of the method 600 need not be necessarily executed in the same order as they are presented. Further, one or more operations may be grouped together and performed in form of a single step, or one operation may have several sub-steps that may be performed in parallel or in sequential manner.

The disclosed methods with reference to FIGS. 2 and 6, or one or more operations of the methods 200 and 600 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

Various embodiments of the present disclosure provide numerous advantages. Embodiments of the present disclosure provide a system 100 and method 600 for random number generation. The LGI-based architecture 102 is a single setup occupying a quarter of an optical table that can further be compactified. Moreover, the LGI-based architecture 102 involves a single photon on which the measurements are made at different times, and spatial separation is not required. As a result, the LGI-based architecture 102 is a semi-device-independent quantum random number generator that can be used to generate random numbers much easier and more efficiently than the spatial Bell-type RNGs. Moreover, the LGI-based architecture 102 addresses the clumsiness loophole, the detection efficiency loophole, the multi-photon emission loophole, the state preparation loophole and the coincidence loophole thereby providing loophole free LGI-based architecture 102 which provides randomness required for generating the random numbers. The LGI-based architecture 102 could be used as a source of randomness for generating random numbers in any application that needs a source of random numbers for its operation. For example, the system 100 could potentially be used in several applications such as secure communication, cryptography, large scale simulations, etc.

It will be understood by those within the art that, in general, terms used herein, and are generally intended as “open” terms (e.g., the term “including” should be interpreted as “including but not limited to,” the term “having” should be interpreted as “having at least,” the term “includes” should be interpreted as “includes but is not limited to,” etc.). For example, as an aid to understanding, the detail description may contain usage of the introductory phrases “at least one” and “one or more” to introduce recitations. However, the use of such phrases should not be construed to imply that the introduction of a recitation by the indefinite articles “a” or “an” limits any particular part of description containing such introduced recitation to inventions containing only one such recitation, even when the introductory phrases “one or more” or “at least one” and indefinite articles such as “a” or “an” (e.g., “a” and/or “an” should typically be interpreted to mean “at least one” or “one or more”) are included in the recitations; the same holds true for the use of definite articles used to introduce such recitations. In addition, even if a specific part of the introduced description recitation is explicitly recited, those skilled in the art will recognize that such recitation should typically be interpreted to mean at least the recited number (e.g., the bare recitation of “two recitations,” without other modifiers, typically means at least two recitations or two or more recitations).

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the detailed description.

We claim:

1. A system for generating random numbers, the system comprising:
a Legget-Garg inequality (LGI) based random number generation architecture, wherein the LGI based random number generation architecture comprises:
a photon source configured to generate a pair of photons comprising a first photon and a second photon;
a pair of dielectric mirrors placed at output path of the photon source and configured to guide the first photon in a first direction and the second photon in a second direction, wherein the first direction and the second direction are opposite to each other;
a plurality of detectors configured to detect the guided pair of photons, wherein the plurality of detectors at least comprises a first detector, a second detector and a third detector, the first detector being placed orthogonally with respect to the photon source in the first direction and configured to detect the first photon;
a pair of interferometers comprising a first interferometer and a second interferometer being placed orthogonally with respect to the photon source in the second direction such that the pair of interferometers guide the second photon towards one of: the second detector and the third detector; and
a first pair of blockers configured to be selectively positioned in a pair of arms of the first interferometer and a second pair of blockers configured to be selectively positioned in a pair of arms of the second interferometer, wherein the first pair of blockers and the second pair of blockers are configured to selectively guide the second photon towards one of: the second detector and the third detector based on positioning of at least one blocker in at least one arm of the pair of interferometers; and
a computing unit operatively coupled to the LGI based random number generation architecture, the computing unit comprising a memory operatively coupled to a processor, wherein the processor is configured to:
receive, from the plurality of detectors, measurement data corresponding to a plurality of measurements performed at a plurality of time instants, wherein the measurement data comprises a plurality of coincidence events corresponding to one of:
detection of the first photon at the first detector and simultaneous detection of the second photon at the second detector, and
detection of the first photon at the first detector and simultaneous detection of the second photon at the third detector,
detect a plurality of coincidence counts from the measurement data; and
generate a plurality of random numbers based on the detected plurality of coincidence counts.

2. The system as claimed in claim 1, wherein:
the first interferometer comprises a half-wave plate and a polarizing beam splitter; and
the second interferometer comprises a non-polarizing beam splitter.

3. The system as claimed in claim 1, wherein the plurality of time instants comprises:
a first time instant corresponding to time taken by the second photon to travel from the polarizing beam splitter to the non-polarizing beam splitter;
a second time instant corresponding to time taken by the second photon to complete a round trip starting from the non-polarizing beam splitter; and
a third time instant corresponding to the time taken for the second photon to be detected at one of: the second detector and the third detector upon completing the round trip.

4. The system as claimed in claim 1, wherein to perform the measurement:
at the first time instant and the third time instant, the first pair of blockers are selectively positioned in the pair of arms of the first interferometer;
at the second time instant and the third time instant, the second pair of blockers are selectively positioned in the pair of arms of the second interferometer; and
at the first time instant and the second time instant, a blocker from the first pair of blockers is selectively positioned in the pair of arms of the first interferometer and a blocker from the second pair of blockers is selectively positioned in the pair of arms of the second interferometer.

5. The system as claimed in claim 1, wherein the measurement data is loophole-free.

6. A method for generating random numbers using a Legget-Garg inequality (LGI) based random number generation architecture, wherein the LGI based random number generation architecture comprises:
a photon source configured to generate a pair of photons comprising a first photon and a second photon;
a pair of dielectric mirrors placed at output path of the photon source and configured to guide the first photon in a first direction and the second photon in a second direction, wherein the first direction and the second direction are opposite to each other;
a plurality of detectors configured to detect the guided pair of photons, wherein the plurality of detectors at least comprises a first detector, a second detector and a third detector, the first detector being placed orthogonally with respect to the photon source in the first direction and configured to detect the first photon;
a pair of interferometers comprising a first interferometer and a second interferometer being placed orthogonally with respect to the photon source in the second direction such that the pair of interferometers guide the second photon towards one of: the second detector and the third detector; and
a first pair of blockers configured to be selectively positioned in a pair of arms of the first interferometer and a second pair of blockers configured to be selectively positioned in a pair of arms of the second interferometer, wherein the first pair of blockers and the second pair of blockers are configured to selectively guide the second photon towards one of: the second detector and the third detector based on positioning of at least one blocker in at least one arm of the pair of interferometers;
the method comprising:
receiving, from the plurality of detectors, measurement data corresponding to a plurality of measurements performed at a plurality of time instants, wherein the measurement data comprises a plurality of coincidence events corresponding to one of:
detection of the first photon at the first detector and simultaneous detection of the second photon at the second detector, and
detection of the first photon at the first detector and simultaneous detection of the second photon at the third detector,
detecting a plurality of coincidence counts from the measurement data; and
generating a plurality of random numbers based on the detected plurality of coincidence counts.

7. The method as claimed in claim 6, wherein:
the first interferometer comprises a half-wave plate and a polarizing beam splitter; and
the second interferometer comprises a non-polarizing beam splitter.

8. The method as claimed in claim 6, wherein the plurality of time instants comprises:
a first time instant corresponding to time taken by the second photon to travel from the polarizing beam splitter to the non-polarizing beam splitter;
a second time instant corresponding to time taken by the second photon to complete a round trip starting from the non-polarizing beam splitter; and
the third time instant corresponding to the time taken for the second photon to be detected at one of: the second detector and the third detector upon completing the round trip.

9. The method as claimed in claim 6, further comprising:
performing the measurement:
at the first time instant and the third time instant by selectively positioning the first pair of blockers in the pair of arms of the first interferometer;
at the second time instant and the third time instant by selectively positioning the second pair of blockers in the pair of arms of the second interferometer; and
at the first time instant and the second time instant by selectively positioning a blocker from the first pair of blockers in the pair of arms of the first interferometer and by selectively positioning a blocker from the second pair of blockers in the pair of arms of the second interferometer.

10. The method as claimed in claim 6, wherein the measurement data is loophole-free.

11. A non-transitory computer readable medium including instructions stored thereon that when processed by a processor, cause a computing unit to perform operations comprising:
receiving, from a plurality of detectors, measurement data corresponding to a plurality of measurements performed at a plurality of time instants, wherein the measurement data comprises a plurality of coincidence events corresponding to one of:
detection of a first photon at a first detector and simultaneous detection of a second photon at a second detector, and
detection of a first photon at a first detector and simultaneous detection of a second photon at a third detector,
detecting a plurality of coincidence counts from the measurement data; and
generating a plurality of random numbers based on the detected plurality of coincidence counts.

12. The non-transitory computer readable medium as claimed in claim 11, wherein:
the first interferometer comprises a half-wave plate and a polarizing beam splitter; and
the second interferometer comprises a non-polarizing beam splitter.

13. The non-transitory computer readable medium as claimed in claim 11, wherein the plurality of time instants comprises:
a first time instant corresponding to time taken by the second photon to travel from the polarizing beam splitter to the non-polarizing beam splitter;
a second time instant corresponding to time taken by the second photon to complete a round trip starting from the non-polarizing beam splitter; and
the third time instant corresponding to the time taken for the second photon to be detected at one of: the second detector and the third detector upon completing the round trip.

14. The non-transitory computer readable medium as claimed in claim 11, wherein the operations further comprises:
performing the measurement:
at the first time instant and the third time instant by selectively positioning the first pair of blockers in the pair of arms of the first interferometer;
at the second time instant and the third time instant by selectively positioning the second pair of blockers in the pair of arms of the second interferometer; and
at the first time instant and the second time instant by selectively positioning a blocker from the first pair of blockers in the pair of arms of the first interferometer and by selectively positioning a blocker from the second pair of blockers in the pair of arms of the second interferometer.

15. The non-transitory computer readable medium as claimed in claim 11, wherein the measurement data is loophole-free.
